(19) United States
(12) Patent Application Publication
(10) Pub. No.: US 2022/0357436 A1
(43) Pub. Date: Nov. 10, 2022

(54) TIME-OF-FLIGHT SENSING CIRCUITRY AND METHOD FOR OPERATING A TIME-OF-FLIGHT SENSING CIRCUITRY

(71) Applicant: Sony Semiconductor Solutions Corporation, Kanagawa (JP)

(72) Inventors: Rachit Mohan, Stuttgart (DE); Luca Cutrignelli, Brussels (BE); Pepe Gil-Cacho, Saint-Josse-ten-Noode (BE)

(73) Assignee: Sony Semiconductor Solutions Corporation, Kanagawa (JP)

(21) Appl. No.: 17/622,430

(22) PCT Filed: Jun. 24, 2020
(86) PCT No.: PCT/EP2020/067710

§ 371 Date: Dec. 23, 2021

(30) Foreign Application Priority Data
Jul. 5, 2019 (EP) 19184643.5

(51) Int. Cl. G01S 7/4865; G01S 17/931; G01S 17/89; G01S 17/06

(52) U.S. Cl. CPC G01S 7/4865; G01S 17/931; G01S 17/89; G01S 17/06

(57) ABSTRACT

The present disclosure generally pertains to a time-of-flight sensing circuitry for sensing image information in different imaging modes, having: a light sensing circuitry for detecting light and outputting light sensing signals; and a logic circuitry for processing the light sensing signals from the light sensing circuitry, wherein the logic circuitry is configured to dynamically set an imaging mode among the different imaging modes.

### TECHNICAL FIELD

The present disclosure generally pertains to a time-of-flight sensing circuitry and to a method for operating a time-of-flight sensing circuitry.

### TECHNICAL BACKGROUND

Generally, time-of-flight systems are known, which are able to determine a distance to a scene or to an object on the basis of a roundtrip delay of emitted light. The light is emitted by a light source of the time-of-flight system and a time-of-flight image sensor detects the light reflected from the scene.

Typically, the time-of-flight image sensor outputs the image information in the form of frames, wherein the content of the frames may be adjusted by setting a configuration of the frames, e.g. by setting the time-of-flight image sensor in an associated operation mode.

A common architecture of time-of-flight systems has a host and the time-of-flight image sensor, wherein the host and the time-of-flight image sensor communicate over a bus with each other, such as the I²C bus system or the like.

In such systems, the host may be configured to control the time-of-flight image sensor, for example, in order to set the time-of-flight image sensor in another operation mode or in order to configure the content of the frames which are output by the time-of-flight image sensor to the host for further processing.

However, typically, this requires intense data communication between the host and the time-of-flight image sensor.

Moreover, known system may be generally limited in programmability options, which means that known systems need to incorporate different types of image sensors.

This may result in an increase in costs and may also complicate the programmability of an image acquisition system.

Although there exist techniques for providing a time-of-flight sensor and a time-of-flight system, it is generally desirable to provide a time-of-flight sensor and a time-of-flight system, which at least partially improve such known time-of-flight sensors and time-of-flight systems.

### SUMMARY

According to a first aspect the disclosure provides a time-of-flight sensing circuitry for sensing image information in different imaging modes, comprising: a light sensing circuitry for detecting light and outputting light sensing signals; a logic circuitry for processing the light sensing signals from the light sensing circuitry, wherein the logic circuitry is configured to dynamically set an imaging mode among the different imaging modes.

According to a second aspect the disclosure provides a method for operating a time-of-flight sensing circuitry for sensing image information in different imaging modes, wherein the time-of-flight sensing circuitry includes a light sensing circuitry for detecting light and outputting light sensing signals and a logic circuitry for processing the light sensing signals from the light sensing circuitry, the method comprising: dynamically setting an imaging mode among the different imaging modes.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 depicts a light sensing circuitry according to an embodiment of the present disclosure in a block diagram;

FIG. 2 depicts an embodiment of an implementation of a sequencer in a ToF sensing circuitry according to the present disclosure in a block diagram;

FIG. 3 schematically illustrates an embodiment of a memory of the sequencer circuitry and an embodiment of an internal trigger sequence;

FIG. 4 illustrates two embodiments of imaging mode sequences;

FIG. 5 shows a ToF camera device in block diagram;

FIG. 6 schematically illustrates on the upper part an embodiment of an imaging mode sequence, as it is implemented in an embodiment of a car environment (lower part); and

FIG. 7 shows a flow chart of a method according to the present disclosure.

### DETAILED DESCRIPTION OF EMBODIMENTS

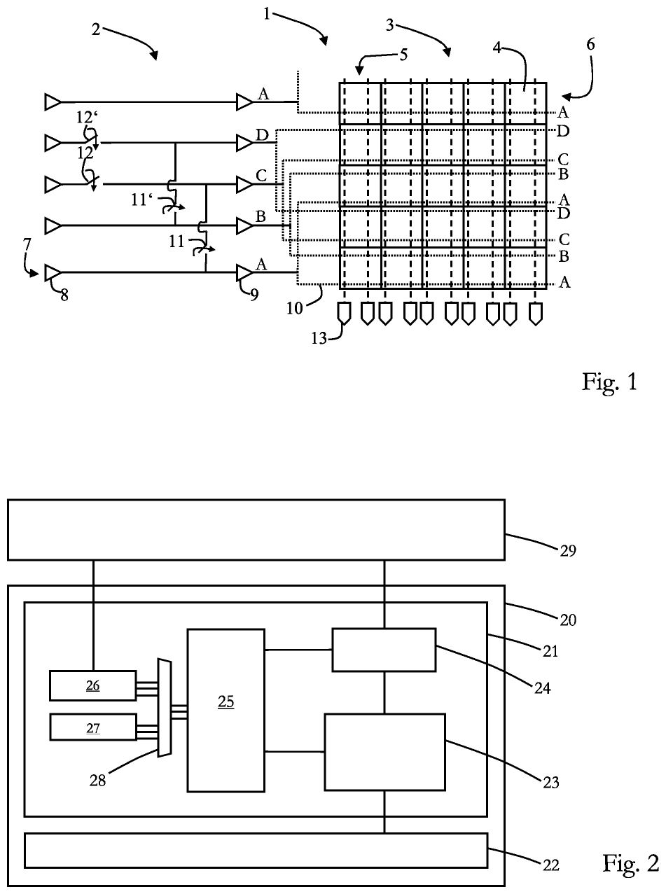

Before a detailed description of the embodiments is given under reference of FIG. 1, some general explanations are made.

As mentioned in the outset, an architecture of time-of-flight (ToF) systems may have a host and a time-of-flight image sensor, and the host and the time-of-flight image sensor may communicate over a bus with each other, such as the I²C bus system, MIPI (Mobile Industry Processor Interface Alliance) or the like, and in such systems, the host may be configured to control the time-of-flight image sensor, for example, in order to set the time-of-flight image sensor in another operation mode or in order to configure the content of the frames which are output by the time-of-flight image sensor to the host for further processing.

It has been recognized that this may not only require intense data communication between the host and the time-of-flight image sensor, but also that a data transfer rate may be slower than a frame rate of the time-of-flight image sensor, which has the consequence that, for instance, a change of the content of the frames on a frame-by-frame basis between two adjacent frames may not be possible, since the communication speed of the bus is too slow compared to the frame rate. Moreover, also the common electronic control of the ToF image sensor may not be fast enough for changing the content of the frames or for switching an operation mode of the ToF image sensor from one frame to the next frame.

Moreover, it has been recognized that it is desirable to have a highly configurable and time-deterministic depth measurement system which can operate in different imaging modes.

Therefore, some embodiments pertain to a time-of-flight sensing circuitry for sensing image information in different imaging modes, having: a light sensing circuitry for detecting light and outputting light sensing signals; and a logic circuitry for processing the light sensing signals from the light sensing circuitry, wherein the logic circuitry is configured to dynamically set an imaging mode among the different imaging modes.

The ToF sensing circuitry may be a (one or more) ToF image sensor for imaging light from a scene, wherein the light stems, for example, from one or more (e.g. two) illumination sources, but the light can also stem from the sun, an environmental illumination, indoor illumination, etc.

Hence, the light sensing circuitry for detecting light and outputting light sensing signals may be based on known technologies for light detection and it may include pixels or photosensitive elements, which may be arranged in an array, or the like, and which may be based on known technologies, such as CMOS (complementary metal-oxide-semiconductor), CCD (charge coupled device), SPAD (single photon avalanche diode), CAPD (current assisted photonic demodulator), etc.

An imaging mode refers in some embodiments to the way of sensing image information. For example, an imaging mode may be the sensing of image information in every driven pixel of the ToF light sensing circuitry (to which is also referred to as full frame mode herein). Another imaging mode may be a binning (e.g. 2×2, 4×4, etc.) mode, wherein a subset or group of (neighboring) pixels are combined or integrated to one information, as it is generally known (to which is also referred to as binned frame mode herein).

Additionally, an imaging mode may refer to a spot ToF mode, in which only one pixel is driven (also an additional light sensing circuitry may be included, which only provides one pixel), refer to a full field mode, in which every pixel is driven, or refer to a mosaicked mode, wherein a predetermined subset or pattern of pixels of the light sensing circuitry is driven at a time, such as every second pixel, only pixels with specific phase information (in the case of indirect ToF), only red pixels (in the case of a hybrid ToF sensor), only a quarter of the pixels, or the like.

In some embodiments it can be distinguished between direct ToF (dToF) and indirect ToF (iToF) for measuring a distance either by measuring the run-time of emitted and reflected light (dToF) or by measuring one or more phase-shifts of emitted and reflected light (iToF), without limiting the present disclosure in that regard.

Moreover, another imaging mode may be the sensing of two-dimensional (2D), three-dimensional (3D), color, infrared information, or the like. Also, a mixture of different imaging modes may be provided, such as 3D and infrared information, or the like.

The light sensing circuitry outputs the light sensing signals, which may be analog and/or digital signals, to the logic circuitry. The light sensing circuitry may include analog-to-digital converters, logic circuits, etc., for generating the light sensing signals.

The logic circuitry for processing the light sensing signals from the light sensing circuitry is configured to dynamically set an imaging mode among the different imaging modes.

For example, the logic circuitry may set the binned frame mode after a predetermined amount of frames, in which the ToF sensing circuitry was driven in the full frame mode. After another predetermined amount of frames of driving the ToF sensing circuitry in the binned frame mode, the logic circuitry may set the full frame mode again, or another imaging mode, e.g. a 2D infrared mode.

In this context, the setting is a dynamical setting in some embodiments.

Also any other imaging mode may be dynamically set. For example, in a first frame a spot ToF mode is set, in a second frame an infrared mode is set and in a third frame a full-field ToF mode is set. Furthermore, in such embodiments, the three frames are repeated for six times, i.e. after the third frame, the spot ToF is set again.

In other words, in some embodiments, the dynamical setting of the imaging mode among the different imaging modes is based on an imaging mode sequence.

However, the imaging mode sequence is not limited to be a periodic sequence as in the embodiment described above. It may include at least one of a predetermined sequence, a random sequence, or a periodic sequence. Furthermore, a random sequence for a predetermined amount of frames may be followed by a periodic sequence for a predetermined amount of frames. In this context, the sequence may be predetermined. There may also be other predetermined sequences, such as a sequence stored in a table, a (pre-)programmed sequence, or the like. The random sequence may also include a pseudo random sequence.

Hence, in some embodiments, the imaging mode sequence may include the definition of how the sequence is generated (e.g. randomly or pseudo randomly, predetermined), but not necessarily the definition of the exact point of time when an imaging mode among the different imaging modes is dynamically set, while in other embodiments the sequence may define the points of time and/or the order, number or other parameters of the dynamical setting of the imaging mode among the different imaging modes.

In some embodiments, the different imaging modes include one or more of a spot time-of-flight mode, a full frame mode, a binned frame mode, an infrared mode, a two-dimensional mode, a full field mode, and a mosaicked mode, as already discussed above.

In some embodiments, in which the ToF sensing circuitry includes an indirect ToF (iToF) sensor, an RoI mode (region of interest), binning and sub-sampling modes (e.g. only taking a sub-set of pixels) may be employed. Thus, the ToF sensing circuitry may be adapted for a field-of-view mode, high-speed applications, low-speed applications, sub-sampled scene, or the like.

In some embodiments the light sensing circuitry is configured to output a light sensing signal of a first type in a first imaging mode and a light sensing signal of a second type in a second imaging mode.

The light sensing signal of the first type and the light sensing signal of the second type may be signals generated in response to a photoelectric conversion process, or the like, as it is generally known and already discussed above, wherein the signals may be in analog or digital form.

In some embodiments, the first imaging mode is a full frame mode and the second imaging mode is a binned frame mode, as discussed herein.

In some embodiments, the first imaging mode includes a first time-of-flight imaging mode for acquiring distance information and the second imaging mode includes an infrared imaging mode for acquiring object information.

Object information may in this context refer to the capturing or the recognition of an object in a field-of-view of the ToF sensing circuitry. The recognition of the object may be performed with object recognition circuitry coupled or included in the ToF sensing circuitry.

Hence, in some embodiments, an object recognition is performed with object recognition circuitry coupled or included in the ToF sensing circuitry.

The object recognition circuitry may be an artificial intelligence, such as a neural network, or the like, applying machine learning algorithms, such as supervised learning, semi-supervised learning, unsupervised learning, reinforcement learning, feature learning, sparse dictionary learning, anomaly detection learning, decision tree learning, association rule learning, or the like.

The machine learning algorithm may further be based on at least one of the following: Feature extraction techniques, classifier techniques or deep-learning techniques. Feature extraction may be based on at least one of: Scale Invariant Feature Transfer (SIFT), Cray Level Co-occurrence Matrix (GLCM), Gaboo Features, Tubeness or the like. Classifiers may be based on at least one of: Random Forest; Support Vector Machine; Neural Net, Bayes Net or the like. Deep learning may be based on at least one of: Autoencoders, Generative Adversarial Network, Weakly Supervised Learning, Boot-Strapping or the like. In some embodiments, the algorithm may be hardcoded on the analysis portion, i.e. the machine learning algorithm may provide an image processing algorithm, a function, or the like, which is then provided at a chip, such as a GPU, FPGA, CPU, or the like, which may save processing capacity instead of storing an artificial intelligence on (parts of) the ToF sensing circuitry.

However, in other embodiments, the machine learning algorithm may be developed and/or used by an (strong or weak) artificial intelligence (such as a neural network, a support vector machine, a Bayesian network, a genetic algorithm, or the like) which constructs the first imaging data, which, in some embodiments, makes it possible that the algorithm may be adapted to a situation, a scene, or the like.

In some embodiments, the algorithm may be hardcoded on (parts of) the ToF sensing circuitry, i.e. the machine learning algorithm may provide an image processing algorithm, a function, or the like, which is then provided at a chip, such as a GPU, FPGA, CPU, or the like, which may save processing capacity instead of storing an artificial intelligence on (parts of) the ToF sensing circuitry.

However, in other embodiments, the machine learning algorithm may be developed and/or used by an (strong or weak) artificial intelligence (such as a neural network, a support vector machine, a Bayesian network, a genetic algorithm, or the like) which constructs the first imaging data, which, in some embodiments, makes it possible that the algorithm may be adapted to a situation, a scene, or the like.

Moreover, in some embodiments, the object recognition may be performed in a car environment (or automotive environment, in general).

The car may provide enough space to provide different light sensing circuitries, such as a spot ToF image sensor, an infrared sensor, a ToF image sensor with a plurality of pixels (in contrast to the spot sensor), a color image sensor, or the like, which may all be included in the ToF sensing circuitry.

Other environments than the car environment may provide a larger amount of light sensing circuitries or a smaller amount of light sensing circuitries. For example, a handheld camera device may provide a spot ToF image sensor and a ToF image sensor with a plurality of pixels.

As discussed, all these light sensing circuities (e.g. image sensors) may be included in one light sensing circuitry (e.g. one programmable image sensor).

In some embodiments, a ToF image sensor with a plurality of pixels may also be used as a spot ToF image sensor by only driving one pixel, which may be chosen differently for different measurements (e.g. randomly, predetermined pattern) or may be the same for every ToF measurement.

In some embodiments, the first time-of-flight imaging mode is a spot time-of-flight imaging mode, as discussed.

In some embodiments, the light sensing circuitry is configured to output a light sensing signal of a third type in a third imaging mode, the third imaging mode including at least one of full-field time-of-flight imaging mode and mosaicked time-of-flight imaging mode.

In some embodiments, the logic circuitry includes a sequencer circuitry and a register circuitry, wherein the register circuitry includes multiple registers for storing data which are derived on the basis of the light sensing signals and wherein each imaging mode of the different imaging modes is based on a predetermined set of registers, and wherein the sequencer circuitry is adapted to dynamically select a set of registers for setting the imaging mode among the different imaging modes.

The sequencer circuitry and the register circuitry are (directly or indirectly) connected with each other or coupled to each other (e.g. over other circuits, units, etc.).

The register circuitry has multiple registers for storing data, wherein the data are derived on the basis of the light sensing signals. The data may be included in the light sensing signals from the light sensing circuitry or they may be derived by the logic circuitry on the basis of the received light sensing signals (or a mixture of both, i.e. partially included in the light sensing signals and partially derived on the basis of the light sensing signals). The data may be indicative for different types of information, such that also the registers include different types of information. The different types of information may be for example, without limiting the present disclosure in that regard, phase information, depth information, color information, or the like, such information for all pixels (light sensing elements) or group of pixels (light sensing elements) or the like of the light sensing circuitry, etc.

The sequencer circuitry may be configured as a unit, logic chip or processor, or the like, it may include further sub-units, memory (memories), etc.

The sequencer circuitry is adapted to dynamically select a set of registers for setting the imaging mode among the different imaging modes.

Depending on the imaging mode, the registers may be different or identical. For example, if a first imaging mode is a spot ToF imaging mode and a second imaging mode is a full field ToF imaging mode, the set of registers may be identical for the first and second imaging mode. they may have partially the same registers or may have completely different registers. Moreover, the number of selected registers in the first and second sets may be equal or different.

On the basis of the selected set, an associated imaging mode can be dynamically provided, e.g. generated. As the sequencer circuitry is in the logic circuitry of the ToF sensing circuitry, the sequencer circuitry may switch between the set of registers for a first and a second imaging mode (or more). Moreover, the sequencer circuitry may be programmed such that first, second and more different imaging modes can be set by setting the registers accordingly without having the need, for example, to switch the ToF sensor in different operating modes. Moreover, as the logic circuitry with the sequencer circuitry sets the first and second sets of registers, there is no additional interaction between a host and the ToF sensor necessary, except for, for example, an initial (or intermediate, dynamic, etc.) programming of the logic circuitry or sequencer circuitry or re-programming, or the like.

The registers can be programmed using an PC interface, SPI interface, or the like. The sequencer can be multiplexed with these interfaces and may be a state-machine, a micro-controller, or the like.

In some embodiments the sequencer circuitry includes a memory for storing sequence configurations, the sequence configurations determining the set of registers and the defined sequence for the generation of the imaging mode sequence.

In general, the memory may be any type of memory, a random-access memory, a non-volatile memory, a storage, etc. The sequence configurations may be in the form of data (bits, data words, file, programming language, etc.) and may be transferred, for example, to the ToF sensor and stored in the memory of the sequencer circuitry. The sequence configurations may include instructions, control data or other information which is used by the sequencer circuitry for determining the sets of registers and for determining the imaging mode sequence, e.g. whether the defined sequence is random, pseudorandom, predetermined (e.g. based on a pattern, regularly, one frame, etc.), etc. Thereby, the sequencer circuitry can be easily programmed by just transferring the sequence configurations in its memory.

In some embodiments, the sequence configurations are divided in a first part and in a second part, wherein the first part defines at least one of: number of imaging modes, location of frames in the imaging mode sequence, trigger for first and second imaging mode, and wherein the second part defines the first and second sets of registers. The first part may be stored in a first part of the memory to and the second part may be stored in a second part of the memory. The first part and second part may be different memory locations in a common memory space or the first part and the second part of the memory may also have different functions and/or may be even structurally separated from each other. For instance, the first part may be for the basic configuration of the sequencer circuitry, e.g. the number of imaging modes, location of frames in the imaging mode sequence, trigger for first and second imaging mode, or the like, wherein the second part includes the sets of registers which are used for generating the associated frames. Hence, during generation of frames, the basic frame structure may be defined by the content in the first part of the memory, while the content of the frames may be defined by the content in the second part of the memory, such that only the second part of the memory may be read out during frame generation.

In some embodiments, the sequencer circuitry is programmable, as also indicated above, e.g. by transmitting the respective sequence configurations to it or by defining the sets of registers, and the imaging mode sequence and transmitting corresponding information to the sequencer circuitry or by storing such information such that the sequencer circuitry can access it.

In some embodiments, the ToF sensor further has a multiplexer and a bus-interface, wherein the bus-interface and the sequencer circuitry are connected via the multiplexer to the register circuitry. The multiplexer may perform time-multiplexing between the sequencer circuitry and the bus-interface. Thereby, a host or other entity can access the register circuitry over the bus-interface while the sequencer circuitry can also access the register. The bus-interface may be, for example, configured for communication over VC bus, MIPI bus, SPI bus, or other bus-systems.

In some embodiments, the ToF sensor further has a controller configured to generate the defined imaging mode sequence on the basis of the selected sets of registers. For instance, the controller reads out the data from the register, on the basis of a predetermined frame rate. As the sequencer circuitry sets the register circuitry in accordance with the first and second sets of registers, the controller will automatically receive and generate the different imaging modes in the order of the defined sequence. The controller may have a processor, logic circuits, memory, etc.

In some embodiments, the sequencer circuitry sets the register circuitry according to the selected sets of registers, such that the register outputs the different imaging modes, e.g. according to the imaging mode sequence. As discussed, the sequencer circuitry may also set the register circuitry in accordance with the sequence configurations discussed above.

In some embodiments, a first imaging mode is configured for providing time-of-flight data and the second imaging mode is configured for providing enhanced sensor data, thereby, for example, a time-of-flight measurement can be performed, wherein simultaneously enhanced sensor data may be received in the second imaging mode, e.g. for improving the time-of-flight measurement, for detecting an interfering other time-of-flight system, for getting diagnostic data from the sensor, etc.

Some embodiments pertain to a method for operating a time-of-flight sensing circuitry for sensing image information in different imaging modes, wherein the time-of-flight sensing circuitry includes a light sensing circuitry for detecting light and outputting light sensing signals and a logic circuitry for processing the light sensing signals from the light sensing circuitry, the method including: dynamically setting an imaging mode among the different imaging modes, as discussed herein.

The method may be performed by a processor, controller or the like and it may be performed by a ToF device including the time-of-flight sensing circuitry discussed herein.

As discussed, in some embodiments, the dynamical setting of the imaging mode among the different imaging modes is based on an imaging mode sequence. In some embodiments the imaging mode sequence includes at least one of a predetermined sequence, a random sequence and a periodic sequence of the different imaging modes, as discussed herein. In some embodiments, the different imaging modes include a spot time-of-flight mode, a full frame mode, a binned frame mode, an infrared mode, a two-dimensional mode, a full field mode, and a mosaicked mode, as discussed herein. In some embodiments, the method further includes: outputting a light sensing signal of a first type in a first imaging mode and a light sensing signal of a second type in a second imaging mode, as discussed herein. In some embodiments, the first imaging mode is a full frame mode and the second imaging mode is a binned frame mode, as discussed herein. In some embodiments, the first imaging mode includes a first time-of-flight imaging mode for acquiring distance information and the second imaging mode includes an infrared imaging mode for acquiring object information, as discussed herein. In some embodiments, the first time-of-flight imaging mode is a spot time-of-flight imaging mode, as discussed herein. In some embodiments, the method further includes: outputting a light sensing signal of a third type in a third imaging mode, the third imaging mode including at least one of full-field time-of-flight imaging mode and mosaicked time-of-flight imaging mode, as discussed herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, a block diagram of a light sensing circuitry 1 according to an embodiment of the present disclosure is depicted. The light sensing circuitry 1 has a driver circuit 2 for driving a ToF image sensor 3 (i.e. a cut-out of a ToF image sensor) with a plurality of pixels 4. The plurality of pixels 4 is arranged in a rectangular shape, such that the ToF image sensor 3 is constructed of columns 5 and rows 6.

The driver circuit 2 drives every row 6 of the ToF image sensor 3 with either a pair of signals A and B or a pair of signals C and D. The driver circuit 2 drives the ToF image sensor 3 via driving lines 7, which are in numbers the same as the number of the rows 6.

For each driving line 7 a clock generator 8 and a clock driver 9 are provided for timing the corresponding driving signal (one of A to D), wherein each driving line 7 is split into two signal lines 10, which are then driving different rows 6, such that every row 6 is driven with the two signals A and B or C and D, as explained above.

Moreover, the driver circuit 2 has two switches 11 and 11′, wherein the switch 11 is configured to couple the ultimate row with the antepenultimate row and the switch 11′ is configured to couple the penultimate row with the preantepenultimate row. If the switches 11 and 11′ are in a connected state, a generated clock signal of the clock generator 8 of the ultimate row is supplied to the antepenultimate row and a generated clock signal of the clock generator 8 of the penultimate row is supplied to the preantepenultimate row.

Thereby, the driving signal C becomes the driving signal A and the driving signal D becomes the driving signal B and the image sensor can be operated in an inverted phase mosaic mode, wherein two phases are measured (or demodulated) in order to acquire depth information.

The driver circuit 2 further includes two switches 12 and 12′, wherein the switch 12 is configured to (in a connected state) supply a clock signal generated by the clock generator 8 of the antepenultimate row to the clock driver 8 of the antepenultimate row, thereby generating the signal C, which is then different from the signal A (in this embodiment). The switch 12 generates the signal D (different from B in this embodiment) in the preantepenultimate row in a similar way.

Thereby, the four lower rows (ultimate to preantepenultimate) are each driven with different signals and a phase mosaic mode (alternate row pattern) is employed, wherein four phases are measured (or demodulated) in order to acquire depth information.

In this embodiment, the switches 12 and 12′ are in connection state when the switches 11 and 11′ are in a disconnection state and vice versa.

However, in other embodiments the connection/disconnection state configuration of the switches are different. For example, the signals C and D are, in some embodiments, generated with the mixture of different clock signals by having all switches in a connection state. In other embodiments, the signal D is generated by closing the switch 12′ and opening the switch 11′, but the signal C is generated by closing both switches 11 and 12. In some embodiments, there is no signal C applied (i.e. both switches 11 and 12 are open). Another way of ensuring that the signals A and C or B and D are the same is to provide the same clock configuration for the respective rows, thereby render switches 11 and 11′ superfluous. There are other configurations of the switches, which are apparent to skilled person.

With the upper row (propreantepenultimate), the described configuration of the driver circuit 2 repeats, without limiting the present disclosure in that regard. Also another driver circuit may be applied or only parts of the driver circuit 2 may be reused, e.g. repeating only the ultimate and the penultimate row.

The light sensing circuitry 1 further includes analog to digital converters (ADC) 13 of which two are applied in each column 5 to convert a signal of a driven pixel 4 of the corresponding column 5. In this embodiment, one ADC 13 of a column 5 converts the signals A and C and the other ADC 13 converts the signals B and D.

The ToF image sensor 3 is configured to and can be programmed to function as an iToF depth sensor, or a 2D infrared image sensor operating in a 2D infrared mode.

By a suitable timing of the respective clock signals and a corresponding readout of generated ADC signals, depth/distance information can be acquired in the (inverted) phase mosaic mode described above.

In the 2D infrared mode, the readout of the ADC signals is not depending on the timing of the signals A to D and the signals A to D do not have to be demodulated, since no depth information is acquired.

In other embodiments, and as already discussed above, further modes of operation can be employed, e.g. binning modes or sub-sampling options by implementing multiplexers prior to the ADC readout.

Moreover, the ToF image sensor 3 can be associated with up to two illumination sources, thus enabling greater flexibility in scene illumination.

For programming the ToF image sensor 3, it can be associated with a sequencer, as described herein.

FIG. 2 depicts an embodiment of an implementation of a sequencer 27 in a ToF sensing circuitry 20 according to the present disclosure in a block diagram.

The ToF sensor 20 has logic circuitry 21 and a light sensing circuitry 22 including an array of light detection pixels, analog-to-digital conversion, etc., such that the light sensing circuitry 22 can output light sensing signals to the logic circuitry 21 in response to detected light.

The log circuitry 21 has a processor/control unit 23, a data interface 24, a register circuitry 25, a bus controller 26 (which is a I²C slave controller), a sequencer circuitry 27 and a multiplexer 28.

The control unit 23 is connected to the light sensing circuitry 22 and receives the light sensing signals from it, which are digitized by analog-to-digital conversion performed by the light sensing circuitry 22, and passes the digitized light sensing signals to the register circuitry 25, to which it is connected, for intermediate storage.

The control unit 23 is also connected to the data interface 24, which, in turn, is connected to a processing unit of a host circuitry 29, such that the processing unit of the host circuitry 29 and the control unit 23 of the ToF sensing circuitry 20 can communicate over the data interface 24 with each other.

On the other hand, the bus controller 26 is connected over an I²C bus with a configuration unit of the host circuitry 29, and it is connected to the register circuitry 25 and to the sequencer circuitry 27 over the multiplexer 28.

Hence, the configuration unit of the host circuitry 29 can transmit control or configuration data/commands over the I²C bus and the bus controller 26 to the sequencer circuitry 27 for controlling and/or configuring the sequencer circuitry 27. For instance, the configuration unit can also transmit imaging sequence configurations as discussed herein to the sequencer circuitry 27.

The control unit 23 is configured to generate data frames, as will also be discussed further below, on the basis of the settings of the registers of the register circuitry 25, which in turn is set by the sequencer circuitry 27, e.g. based on sequence configurations received from the configuration unit of the host circuitry 29.

In this embodiment, the ToF sensing circuitry is real-time configurable, since the sequencer circuitry 27 is able to change the type of frame from one frame to another by changing the associated register setting, such that, for example, during operation different imaging modes can be dynamically set.

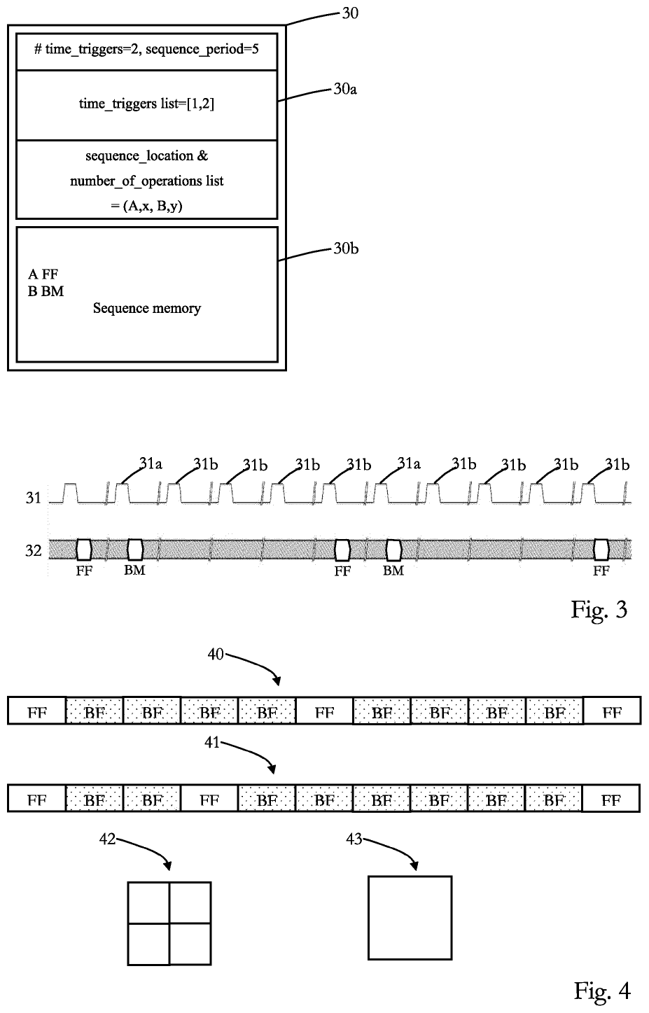

FIG. 3 schematically illustrates an embodiment of a memory 30 of the sequencer circuitry 27 for storing imaging sequence configurations, which may be received from the configuration unit of the host to circuitry 29 and which configure the sequencer circuitry 27 and its states (such that the sequencer circuitry 27 may also be considered as a state machine).

The memory 30 has a first part 30a and a second part 30b, wherein a first part of sequence configurations is stored in the first part 30a and a second part of sequence configuration is stored in the second part 30b. The memory 30 is a SRAM (static random access memory) in this embodiment, and the first part 30a and the second part 30b are logically separated from each other.

The first part of sequence configurations includes, for example: number of types of frames, location of frames in the sequence of frames, trigger for first, second, etc. type of frames, etc.

In the first part 30a, three data fields are illustrated, wherein the upper data field stores a number of triggers (e.g. time, “# time_triggers”) and the period of a sequence (“sequence_period”), such that, for example, it is defined how often a specific frame is repeated.

In a second data field, in the middle, a list of the triggers is stored (“time_triggers list”), which indicates when and where in a sequence a specific frame type will be applied.

In a third data field, at the bottom, for instance, a sequence location is stored, i.e. a location (“sequence_location”) and a length of the sequence (“number_of_operations list”) in the second (sequence memory) part 30b are stored.

The second part of sequence configurations includes, for example, (first, second, etc.) sets of registers on the basis of which the frames are generated by the control unit 23.

In this embodiment, the number of triggers is two (“# time_triggers=2”) and the period of the imaging sequence is five (“seq_p=5”), the entries in the time trigger list are [1,2], and the locations of the sequences in the memory part 30b are “A” with a length “x”, and “B” with a length “y”, which is illustrated also as memory entries in the memory part 30a.

In the memory part 30b, the associated sequences defining the sets of registers for sequence “FF” corresponding to a full frame sequence and “BM” corresponding to a binned frame (having a lower resolution) are stored at the memory locations A and B, respectively, wherein the first sequence “FF” has a set of registers for one FF frame (e.g. second imaging mode) and the second sequence “BM” has a second set of registers such that four binned frames (e.g. first imaging mode) are generated, wherein the ToF sensing circuitry sensor 1 is also switched between a full frame mode and a binned frame mode for providing accordingly the light sensing signal and data.

Hence, in this embodiment, a bandwidth limitation due to a higher pixel count is overcome by applying a hybrid mode, wherein the operation switches between different modes, which combine benefits on execution time and quality, wherein in the present embodiment between the binning mode BM and the full resolution mode FF is switched, wherein, as mentioned, in the BM mode four frames are generated.

This means, assuming that the FF mode has a first set of registers Set_1 for generating the FF frame and the BM mode as a second set of registers Set_2 for generating the BM frames, a timing is as follows:

[switch full resolution mode] Set_1, [switch to binned mode], Set_2, Set_2, . . . , Set_2, [repeat]

In other words, the number of four BM frames is generated by repeating the associated set of registers accordingly in the associated sequence.

In the present embodiment, without limiting the present disclosure in that regard, the full resolution mode FF is used at a frame rate of 5 fps (frames per second) and the binned mode at a frame rate of 30 fps.

Hence, in some embodiments, the frame rate for the first and second imaging modes may be different.

In the lower part of FIG. 3, an internal trigger sequence 31 is shown, wherein each peak 31a triggers setting Set_1 and, thus, generation of FF frames, and each peak 31b switches to the setting Set_2 and the generation of BM frames.

At 32, a control command structure is illustrated, wherein a first command “FF” causes the trigger peak 31a and the second command “BM” causes the trigger peaks 31b, such that one FF frame is generated and consecutively four BM frames.

FIG. 4 illustrates two embodiments of imaging mode sequences 40 and 41.

The imaging mode sequence 40 starts with a full frame FF (in the FF mode) with a high resolution output, then includes four binned frames BF (in the BM mode) with a low resolution output. This cycle is repeated once and then the imaging mode sequence 40 ends with a full frame FF.

The full frame mode has a higher resolution than the binned frame mode, but also needs more processing power and therefore more processing time. Thus, the full frame mode cannot be used at a high frame rate. In the imaging mode sequence 40, the FF mode can operate at a low frame rate (e.g. 5 fps) and the BM mode can operate at a higher frame rate (e.g. 20 fps). The overall frame grate is therefore higher than having only full frames.

The imaging mode 41 starts with a full frame FF, followed by two binned frames BF, which is in turn followed by a full frame FF and six binned frames BF, and then ends with a full frame FF.

The lower part of FIG. 4 depicts two illustrations of how pixels are read out in the respective modes.

The illustration 42 shows an image sensor with four pixels (the number of pixels is chosen for illustrational purposes only), which are all read out in the FF mode.

The illustration 43 shows the same image sensor, still having four pixels, but a 2×2 binning is applied in order to generate a binned frame BF in the BM mode.

FIG. 5 shows a ToF camera device 50 in a block diagram, which includes a programmable sensor 51 (ToF sensing circuitry), a first illumination 52 and a second illumination 53. The first illumination 52 is associated with a first imaging mode and the second illumination is associated with a second imaging mode, thus enabling flexibility in scene illumination.

In this embodiment, the first illumination 52 is associated with the FF mode, which needs more processing capacity than the BM mode. Therefore, the frame rate of the FF mode is lower and the first illumination 52 is therefore a “slow” illumination illuminating as slow as the frame rate of the FF mode during the FF mode. The second illumination 53 is a “fast” illumination configured to illuminate the scene as fast as the frame rate of the BM mode during the BM mode.

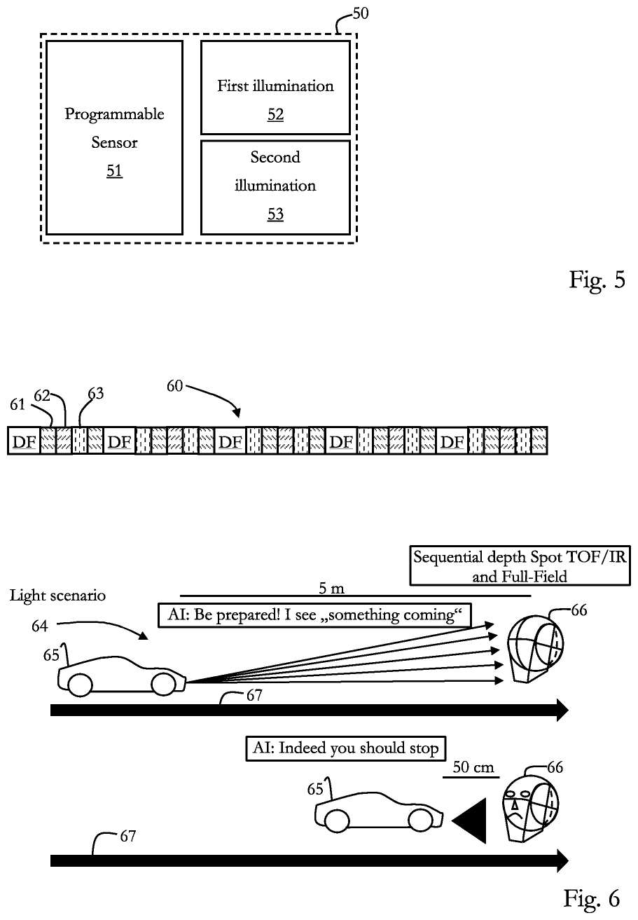

FIG. 6 schematically illustrates on the upper part an embodiment of an imaging mode sequence 60, as it is implemented in an embodiment of a car environment (lower part).

The imaging mode sequence 60 starts with a dark frame DF (no light sensing), which is in this embodiment used for a resetting of the ToF sensing circuitry. Then follows a sequence of a first frame 61 in a spot ToF mode (first imaging mode), a second frame 62 in a passive IR imaging mode (second imaging mode and a third frame 63 in a full field ToF imaging mode (third imaging mode), wherein the different frames are represented with different hatchings. Then follows a sequence of the dark frame DF, the third frame 63, the first frame 61, the second frame 62, the third frame 63 and a third frame 62. This sequence is repeated four times.

The imaging mode sequence 60 is applied in a car environment depicted in the lower part of FIG. 6.

A first scene 64 shows a car 65 having a ToF sensing circuitry according to the present disclosure (not depicted). The ToF sensing circuitry is configured to dynamically set the three different imaging modes 61 to 63 (and the dark frame) according to the imaging mode sequence 60.

In the first scene 64, it is recognized with the spot ToF mode that the car 65 is five meters away from an object 66. To save processing power for objects which are above a threshold distance (in this embodiment roughly 50 cm), only information of the spot ToF mode and the passive IR mode are transmitted to a computer included in the car 65, which stores an artificial intelligence (AI).

The AI performs an object recognition and recognizes an obstacle in the driving direction of the car 65. The AI transmits the message: “Be prepared! I see “something coming”” to warn the driver of the obstacle. Below the threshold distance, information of the full field ToF mode is adopted and the AI recognizes the object 66 to be a person. The AI transmits the message “Indeed you should stop”.

In other embodiments, the AI is configured to stop the car itself.

In this embodiment, dynamic range operation can be obtained, which leads to a reduction in overall costs.

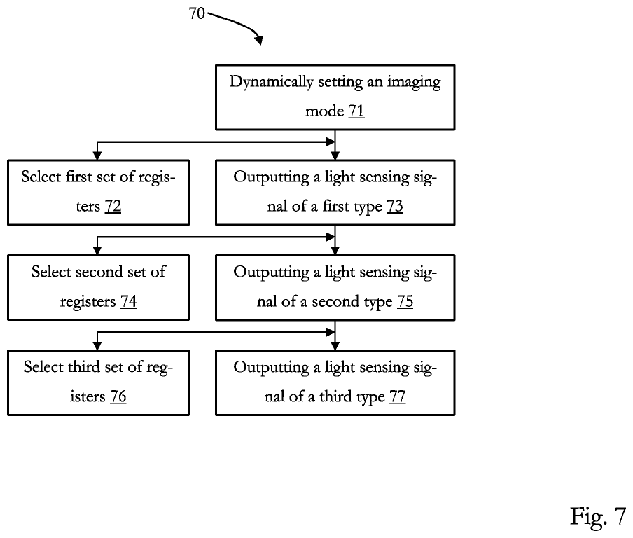

FIG. 7 shows a method 70 according to the present disclosure in a flow chart.

In 71, an imaging mode is dynamically set, as described herein.

Therefore, in 72, a first set of registers is selected for a first imaging mode and in 73 a light sensing signal of a first type is output in the first imaging mode.

In 74, a second set of registers is selected for a second imaging mode and in 75 a light sensing signal of a second type is output in the second imaging mode.

In 76, a third set of registers is selected for a third imaging mode and in 77 a light sensing signal of a third type is output in the third imaging mode.

In other embodiments, this method is repeated a predetermined amount of times, as it is described herein.

It should be recognized that the embodiments describe methods with an exemplary ordering of method steps. The specific ordering of method steps is however given for illustrative purposes only and should not be construed as binding. For example the ordering of 73 and 75 in the embodiment of FIG. 7 may be exchanged. Also, the ordering of 72, 74 and 76 in the embodiment of FIG. 7 may be exchanged. Further, also the ordering of 72 and 73 in the embodiment of FIG. 7 may be exchanged. Other changes of the ordering of method steps may be apparent to the skilled person.

Please note that the division of the ToF device 50 into units 51 to 53 is only made for illustration purposes and that the present disclosure is not limited to any specific division of functions in specific units. For instance, the control 51 could be implemented by a respective programmed processor, field programmable gate array (FPGA) and the like.

All units and entities described in this specification and claimed in the appended claims can, if not stated otherwise, be implemented as integrated circuit logic, for example on a chip, and functionality to provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) A time-of-flight sensing circuitry for sensing image information in different imaging modes, comprising:
a light sensing circuitry for detecting light and outputting light sensing signals; and
a logic circuitry for processing the light sensing signals from the light sensing circuitry, wherein the logic circuitry is configured to dynamically set an imaging mode among the different imaging modes.

(2) The time-of-flight sensing circuitry according to (1), wherein the dynamical setting of the imaging mode among the different imaging modes is based on an imaging mode sequence.

(3) The time-of-flight sensing circuitry according to (2), wherein the imaging mode sequence includes at least one of a predetermined sequence, a random sequence and a periodic sequence of the different imaging modes.

(4) The time-of-flight sensing circuitry according to anyone of (1) to (3), wherein the different imaging modes include a spot time-of-flight mode, a full frame mode, a binned frame mode, an infrared mode, a two-dimensional mode, a full field mode, and a mosaicked mode.

(5) The time-of-flight sensing circuitry according to anyone of (1) to (4), wherein the light sensing circuitry is configured to output a light sensing signal of a first type in a first imaging mode and a light sensing signal of a second type in a second imaging mode.

(6) The time-of-flight sensing circuitry according to (5), wherein the first imaging mode is a full frame mode and the second imaging mode is a binned frame mode.

(7) The time-of-flight sensing circuitry according to anyone of (5) and (6), wherein the first imaging mode includes a first time-of-flight imaging mode for acquiring distance information and the second imaging mode includes an infrared imaging mode for acquiring object information.

(8) The time-of-flight sensing circuitry according to (7), wherein the first time-of-flight imaging mode is a spot time-of-flight imaging mode.

(9) The time-of-flight sensing circuitry according to anyone of (5) to (8), wherein the light sensing circuitry is configured to output a light sensing signal of a third type in a third imaging mode, the third imaging mode including at least one of full-field time-of-flight imaging mode and mosaicked time-of-flight imaging mode.

(10) The time-of-flight sensing circuitry according to anyone of (1) to (9), wherein the logic circuitry includes a sequencer circuitry and a register circuitry, wherein the register circuitry includes multiple registers for storing data which are derived on the basis of the light sensing signals and wherein each imaging mode of the different imaging modes is based on a predetermined set of registers, and wherein the sequencer circuitry is adapted to dynamically select a set of registers for setting the imaging mode among the different imaging modes.

(11) A method for operating a time-of-flight sensing circuitry for sensing image information in different imaging modes, wherein the time-of-flight sensing circuitry includes a light sensing circuitry for detecting light and outputting light sensing signals and a logic circuitry for processing the light sensing signals from the light sensing circuitry, the method comprising:
dynamically setting an imaging mode among the different imaging modes.

(12) The method according to (11), wherein the dynamical setting of the imaging mode among the different imaging modes is based on an imaging mode sequence.

(13) The method according to (12), wherein the imaging mode sequence includes at least one of a predetermined sequence, a random sequence and a periodic sequence of the different imaging modes.

(14) The method according to anyone of (11) to (13), wherein the different imaging modes include a spot time-of-flight mode, a full frame mode, a binned frame mode, an infrared mode, a two-dimensional mode, a full field mode, and a mosaicked mode.

(15) The method according to anyone of (11) to (14), further comprising:
outputting a light sensing signal of a first type in a first imaging mode and a light sensing signal of a second type in a second imaging mode.

(16) The method according to (15), wherein the first imaging mode is a full frame mode and the second imaging mode is a binned frame mode.

(17) The method according to anyone of (15) and (16), wherein the first imaging mode includes a first time-of-flight imaging mode for acquiring distance information and the second imaging mode includes an infrared imaging mode for acquiring object information.

(18) The method according to (17), wherein the first time-of-flight imaging mode is a spot time-of-flight imaging mode.

(19) The method according to anyone of (15) to (18), further comprising:
outputting a light sensing signal of a third type in a third imaging mode, the third imaging mode including at least one of full-field time-of-flight imaging mode and mosaicked time-of-flight imaging mode.

(20) The method according to anyone of (11) to (19), wherein the logic circuitry includes a sequencer circuitry and a register circuitry, wherein the register circuitry includes multiple registers for storing data which are derived on the basis of the light sensing signals and wherein each imaging mode of the different imaging modes is based on a predetermined set of registers, the method further comprising:
dynamically selecting a set of registers for setting the imaging mode among the different imaging modes.

(21) A computer program comprising program code causing a computer to perform the method according to anyone of (11) to (20), when being carried out on a computer.

(22) A non-transitory computer-readable recording medium that stores therein a computer program product, which, when executed by a processor, causes the method according to anyone of (11) to (20) to be performed.

1. A time-of-flight sensing circuitry for sensing image information in different imaging modes, comprising:
a light sensing circuitry for detecting light and outputting light sensing signals; and
a logic circuitry for processing the light sensing signals from the light sensing circuitry, wherein the logic circuitry is configured to dynamically set an imaging mode among the different imaging modes.

2. The time-of-flight sensing circuitry according to claim 1, wherein the dynamical setting of the imaging mode among the different imaging modes is based on an imaging mode sequence.

3. The time-of-flight sensing circuitry according to claim 2, wherein the imaging mode sequence includes at least one of a predetermined sequence, a random sequence and a periodic sequence of the different imaging modes.

4. The time-of-flight sensing circuitry according to claim 1, wherein the different imaging modes include a spot time-of-flight mode, a full frame mode, a binned frame mode, an infrared mode, a two-dimensional mode, a full field mode, and a mosaicked mode.

5. The time-of-flight sensing circuitry according to claim 1, wherein the light sensing circuitry is configured to output a light sensing signal of a first type in a first imaging mode and a light sensing signal of a second type in a second imaging mode.

6. The time-of-flight sensing circuitry according to claim 5, wherein the first imaging mode is a full frame mode and the second imaging mode is a binned frame mode.

7. The time-of-flight sensing circuitry according to claim 5, wherein the first imaging mode includes a first time-of-flight imaging mode for acquiring distance information and the second imaging mode includes an infrared imaging mode for acquiring object information.

8. The time-of-flight sensing circuitry according to claim 7, wherein the first time-of-flight imaging mode is a spot time-of-flight imaging mode.

9. The time-of-flight sensing circuitry according to claim 5, wherein the light sensing circuitry is configured to output a light sensing signal of a third type in a third imaging mode, the third imaging mode including at least one of full-field time-of-flight imaging mode and mosaicked time-of-flight imaging mode.

10. The time-of-flight sensing circuitry according to claim 1, wherein the logic circuitry includes a sequencer circuitry and a register circuitry, wherein the register circuitry includes multiple registers for storing data which are derived on the basis of the light sensing signals and wherein each imaging mode of the different imaging modes is based on a predetermined set of registers, and wherein the sequencer circuitry is adapted to dynamically select a set of registers for setting the imaging mode among the different imaging modes.

11. A method for operating a time-of-flight sensing circuitry for sensing image information in different imaging modes, wherein the time-of-flight sensing circuitry includes a light sensing circuitry for detecting light and outputting light sensing signals and a logic circuitry for processing the light sensing signals from the light sensing circuitry, the method comprising:
dynamically setting an imaging mode among the different imaging modes.

12. The method according to claim 11, wherein the dynamical setting of the imaging mode among the different imaging modes is based on an imaging mode sequence.

13. The method according to claim 12, wherein the imaging mode sequence includes at least one of a predetermined sequence, a random sequence and a periodic sequence of the different imaging modes.

14. The method according to claim 11, wherein the different imaging modes include a spot time-of-flight mode, a full frame mode, a binned frame mode, an infrared mode, a two-dimensional mode, a full field mode, and a mosaicked mode.

15. The method according to claim 11, further comprising:
outputting a light sensing signal of a first type in a first imaging mode and a light sensing signal of a second type in a second imaging mode.

16. The method according to claim 15, wherein the first imaging mode is a full frame mode and the second imaging mode is a binned frame mode.

17. The method according to claim 15, wherein the first imaging mode includes a first time-of-flight imaging mode for acquiring distance information and the second imaging mode includes an infrared imaging mode for acquiring object information.

18. The method according to claim 17, wherein the first time-of-flight imaging mode is a spot time-of-flight imaging mode.

19. The method according to claim 15, further comprising:
outputting a light sensing signal of a third type in a third imaging mode, the third imaging mode including at least one of full-field time-of-flight imaging mode and mosaicked time-of-flight imaging mode.

20. The method according to claim 11, wherein the logic circuitry includes a sequencer circuitry and a register circuitry, wherein the register circuitry includes multiple registers for storing data which are derived on the basis of the light sensing signals and wherein each imaging mode of the different imaging modes is based on a predetermined set of registers, the method further comprising:
dynamically selecting a set of registers for setting the imaging mode among the different imaging modes.
